(19) United States
(12) Patent Application Publication
(10) Pub. No.: US 2012/0303424 A1
(43) Pub. Date: Nov. 29, 2012

(54) METHOD AND SOFTWARE FOR GENERATING REMINDER MESSAGES FOR INSURANCE PRODUCT LEADS

(75) Inventor: Brett E. Lundstrom, Huntley, IL (US)

(73) Assignee: Lundstrom Insurance Agency, Inc., Elgin, IL (US)

(21) Appl. No.: 13/117,899

(22) Filed: May 27, 2011

(51) Int. Cl. G06Q 30/00; G06Q 10/00

(52) U.S. Cl. 705/14.4; 705/1.1

(57) ABSTRACT

A method and a software product for generating reminders for a customer. Customer information, including a customer contact and a future date for contacting the customer, is received through a user interface in combination with a data processor. The customer information is stored in a database in communication with the data processor. The data processor automatically generates a reminder at the future date or at a predetermined time prior to the future date to allow for contacting the customer at the future date or at the predetermined time prior to the future date.

### FIELD OF THE INVENTION

This invention relates generally to a method and software for receiving, organizing, and managing a sales lead and, more particularly, to a method and software for generating a message to sales personnel to respond to a sales inquiry, such as at a future date.

### BACKGROUND OF THE INVENTION

There are many products and services that people not only need, but need them at particular times. For example, products and services that are handled on an annual or other timed contract basis, such as insurance and other financial and service products, have a narrow window prior to a renewal date where a potential customer is actively considering and shopping for comparison products or services. For sales personnel, finding this particular opportunity window to connect with potential customers can be a frustrating endeavor. A person may express genuine interest in one's product or service, but not be yet able to make a switch. Then, when the appropriate time arrives for the person to consider switching product or service providers, the person has forgotten the other offer or simply too busy or distracted to spend time or remember to start the shopping process. Soon it is too late and the current product or service contract is simply renewed.

There is a continuing need for improving the connection of companies with potential customers, at the appropriate time for the customer to be open to the companies' products or services.

### SUMMARY OF THE INVENTION

A general object of the invention is to provide an improved method of customer information intake, with an automatic association of the customer information with a date for contacting that customer. A more specific objective of the invention is to overcome one or more of the problems described above.

The general object of the invention can be attained, at least in part, through a method for contacting a customer. The method includes receiving customer information through a user interface in combination with a data processor. The customer information can include various information such as a customer contact and a future date for contacting the customer. The method further includes storing the customer information in a database in communication with the data processor; automatically generating a reminder at the future date or at a predetermined time prior to the future date; and contacting the customer with product information at the future date or at the predetermined time prior to the future date. The product information can be a financial product information, such as insurance products, and the future date can be a renewal date or maturity date.

The invention further contemplates a software product stored on a machine readable medium and executable by a computer for generating reminders for a customer. The software product includes first program instructions to display a user interface including information fields fillable with customer information, the customer information including a customer contact and a future date for contacting the customer; second program instructions to save the customer information in a database; and third program instructions to automatically generate and send a reminder message at the future date or at a predetermined time prior to the future date.

The invention has applicability to various and alternative situation where a reminder message is needed for a future date. The invention can be used for sales efforts, as a reminder to contact a potential or actual customer at or before a future date. The invention has particular benefit for financial products, such as insurance products, where the product is time restrictive. The future contact date can be set at a date sufficiently before a customer renewal date or customer maturity date to allow reviewing new or additional options.

Other objects and advantages will be apparent to those skilled in the art from the following detailed description taken in conjunction with the appended claims and drawings.

### BRIEF DESCRIPTION OF THE DRAWINGS

FIG. 1 is a flow chart illustrating one embodiment of this invention.

FIG. 2 illustrates a user interface according to one embodiment of this invention.

### DETAILED DESCRIPTION OF THE INVENTION

The present invention provides a method for receiving, managing, and following up or otherwise reconnecting on an inquiry. The invention also provides software for implementing the method, and having coded instruction recorded on a recordable memory medium and executable on a data processor. The invention is particularly suited for the sales of insurance products, and is described herein in this regard, but is not intended to be so limited. The invention has broad applicability, such as for, without limitation, personal reminders, social gathering reminders, and/or various campaign or event reminders, in addition to sales of other products or services, such as time-sensitive products or services requiring contract renewals, including, without limitation, particular financial products such as Certificates of Deposits, auto leasing or servicing, home and lawn maintenance, or medical appointments. The invention can also be implemented for products and services that are not time sensitive, but for any of various reasons the potential customer is not available for consideration at the present time.

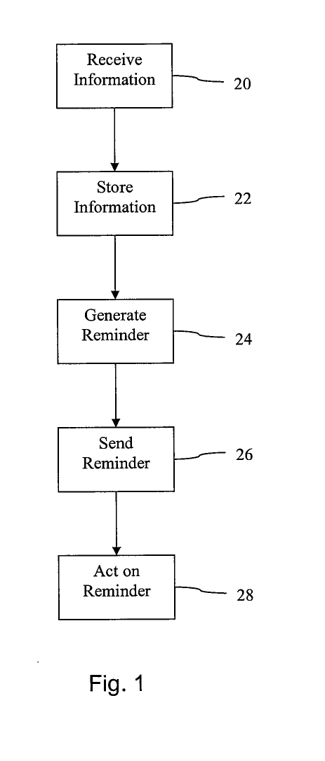

FIG. 1 is a flow diagram illustrating a method of contacting another party, such as a potential or actual customer. For illustration purposes, the party will be described as a potential insurance customer. In box 20, customer information for the potential customer is received through a user interface in combination with a data processor machine. Receiving the customer information can be, for example, the result of a personal encounter with a salesperson or the customer visiting a company web site. The customer information is desirably received through the user interface, which can be a web site or a mobile device application that can be accessed by the customer alone or during a meeting or conversation with a salesperson.

The customer information received can vary depending on need and the product or service that is being offered and considered by the customer. In one embodiment of this invention, the customer information includes at a minimum customer contact information, such as, for example, name, address, phone number, e-mail address, and/or social networking identification. The customer information also desirably includes one or more future date(s) by which the customer wishes to be contacted to further discuss the offered products and/or services. Other optional customer information can include the particular type of product or service of interest (if there are multiple types available), company name, age, salesperson or referral information, and/or preferred method of contact.

In box 22, the customer information is stored in a database in communication with the data processor. The database is desirably stored in combination with a server machine in control of the company seeking the business of the potential customer. The server machine can include the software for generating the user interface for receiving the customer information and for communicating with a remote machine in the presence of the customer and displaying or otherwise acting as the user interface.

The method and software of this invention provide a particular benefit in automatically generating, in box 24, a reminder message in response to the stored customer information. The reminder message can be generated at the future date selected and/or entered by the customer, or the reminder can be generated at a predetermined time prior to the future date. In one embodiment of this invention, the reminder message can be generated as a notification message immediately upon receipt of the customer input. However, for purposes of contacting the customer at a time near the future date, the reminder message or a second reminder message is desirably generated and forwarded at or near the future date. The time when a reminder message should be generated is dependent on need and the particular customer and/or product or service being offered. If the entered future date is a renewal or maturity date, then the first or second reminder message should be generated sufficiently before the future date. If the future date is a date established by the customer before a renewal or maturity date, then the first or second reminder message can be generated and forwarded on the future date.

In box 26, the reminder message is automatically sent by the server machine to the appropriate person(s), such as for example, a salesperson, for action. The reminder message can be sent by any suitable method, such as, without limitation, e-mail, text message, instant message, and/or as an automatically added item to an electronic calendar. In one embodiment, the salesperson receiving the reminder can be the salesperson that initially met with the customer. The customer information can include the salesperson's information, or the device through which the customer information is collected can tag the customer with the salesperson's name. The salesperson can also be unknown to the customer, and selected randomly or based upon a determined order, hierarchy, or other suitable metric.

In box 28, the customer is contacted with product information, e.g., insurance policy information, at the future date or at the predetermined time prior to the future date. The customer can be contacted automatically by the server computer in addition to or instead of the salesperson, by generating or sending a standard or tailored reminder message to the customer. Desirably however, the salesperson who received the reminder message in step 26 contacts the customer as needed.

The invention also includes software for implementing the method of the invention. In one embodiment of this invention, the software product includes coded and executable program instructions stored on a machine readable medium and executable by a data processing machine, such as the server machine discussed above, for generating reminders for a customer. The software includes first program instructions to display a user interface including information fields fillable with customer information. The software product includes second program instructions to save the customer information in a database, such as described previously. The software product includes third program instructions to automatically generate and send a reminder message at the future date or at a predetermined time prior to the future date, such as described previously.

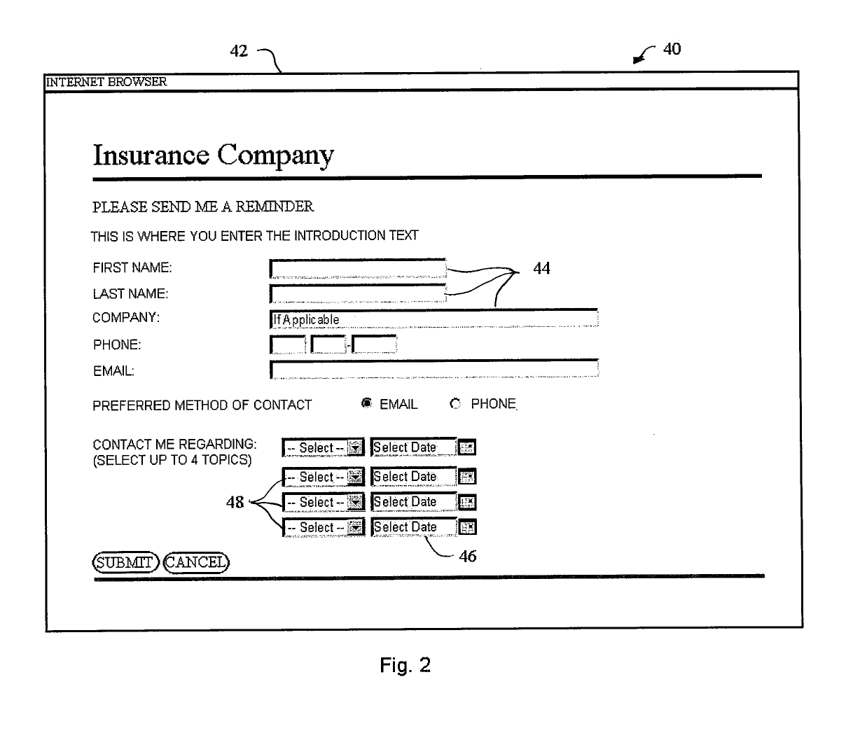

FIG. 2 illustrates an exemplary user interface, and more particularly a graphical user interface (GUI) 40. The GUI 40 is displayed in a web browser window 42, such as on a computer screen or a mobile device user interface. The GUI 40 is created by a server machine and displayed over a network, such as the Internet, to a remote computer or mobile device. The GUI 40 includes general information, such as the name of the company and a general description of the purpose of the web page. The GUI 40 includes fillable information fields 44 for receiving entered customer information. The GUI 40 also includes more than one field 46 for identifying a future date. Each of the future date fields 46 is paired with a corresponding selectable field 48 that includes a drop down list of available products or other reasons for the reminder. In the particular GUI 40 shown in FIG. 2, there are four future date fields 46 each associated with a corresponding selectable filed 48. Desirably in FIG. 2, there are at least four options available for selection in each of the fields 48. As will be appreciated by those of ordinary skill in the art following the teachings herein provided, various and alternative fields and layout configurations are available for the GUI 40.

Thus, the invention provides a method and software for generating a reminder message for responding to a sales inquiry, such as at a future date. The invention automates through software the intake of customer information and associates each customer with a particular date the customer wants to be contacted.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A method for contacting a customer, comprising:
receiving customer information through a user interface in combination with a data processor, wherein the customer information includes a customer contact and a future date for contacting the customer;
storing the customer information in a database in communication with the data processor;
automatically generating a reminder at the future date or at a predetermined time prior to the future date; and
contacting the customer with product information at the future date or at the predetermined time prior to the future date.

2. The method according to claim 1, wherein the product information comprises a financial product information and the future date comprises a customer renewal date or customer maturity date.

3. The method according to claim 1, wherein contacting the customer comprises automatically sending a message.

4. The method according to claim 3, wherein the message is automatically sent using a data processor to the customer.

5. The method according to claim 3, wherein the message is automatically sent using a data processor to a salesperson.

6. The method according to claim 1, wherein the customer information is entered using a customer data processor and transferred to the database via a network.

7. The method according to claim 1, further comprising a server machine generating the user interface and receiving the customer information.

8. The method according to claim 7, wherein the customer information includes more than one future date.

9. The method according to claim 7, wherein the user interface comprises selectable fields each including a listing of more than one product type, and each of the selectable fields is associated with a field for a corresponding future date.

10. A software product stored on a machine readable medium and for generating reminders for a customer, comprising:
first program instructions to display a user interface including information fields fillable with customer information, the customer information including a customer contact and a future date for contacting the customer;
second program instructions to save the customer information in a database; and
third program instructions to automatically generate and send a reminder message at the future date or at a predetermined time prior to the future date.

11. The software product of claim 10, wherein the reminder message comprises financial product information and the future date comprises a customer renewal date or a customer maturity date.

12. The software product of claim 10, wherein the third program instructions generate and send the reminder message directly to the customer.

13. The software product of claim 12, wherein the third program instructions sends a copy of the reminder message to a salesperson.

14. The software product of claim 10, wherein the third program instructions generate and send a reminder message including the customer information to a salesperson.

15. The software product of claim 10, wherein the customer information is entered using a customer data processor and transferred to the database via a network.

16. The software product of claim 10, wherein the machine readable medium is part of a server machine that operates the instructions to generate the user interface and receive the customer information.

17. The software product of claim 10, wherein the customer information includes more than one future date.

18. The software product of claim 17, wherein the user interface comprises selectable fields each including a listing of more than one product type, and each of the selectable fields is associated with a field for a corresponding future date.
